(19) United States
(12) Patent Application Publication
(10) Pub. No.: US 2008/0022462 A1
(43) Pub. Date: Jan. 31, 2008

(54) Battery powered vehicle jack and wrench kit

(76) Inventor: Tony L. Benson, Grandview, TX (US)

Correspondence Address: JAMES RAY & ASSOCIATES, 2640 PITCAIRN ROAD, MONROEVILLE, PA, 15146, US

(21) Appl. No.: 11/823,981

(22) Filed: Jun. 29, 2007

Related U.S. Application Data
(60) Provisional application No. 60/833,766, filed on Jul. 28, 2006.

(51) Int. Cl. B25B 21/00; B60B 29/00; B66F 3/44

(52) U.S. Cl. 7/100

(57) ABSTRACT

A battery powered vehicle jack and wrench kit comprising a battery powered hydraulic jack having a body, a top end and bottom end, for raising and lowering a vehicle, a battery powered impact wrench for tightening and loosening lugnuts on a vehicle. There is a power cord engageable at a respective first end thereof with terminals located on one of such hydraulic jack and such impact wrench and having a means for connecting to a vehicle battery at a respective second end for providing power to a control means. A predetermined plurality of sockets engageable at a first end with the impact wrench and engageable at a second end thereof with a vehicle lugnut and a case for containing such hydraulic jack, impact wrench, power cord and predetermined plurality of sockets therein are included.

### CROSS-REFERENCE TO RELATED APPLICATIONS

This application is related to and claims priority from U.S. Provisional Patent Application Ser. No. 60/833,766 filed on Jul. 2, 2006.

### FIELD OF THE INVENTION

The present invention generally relates to vehicle tire changing kits. More particularly, the invention relates to a portable vehicle jack and a wrench kit capable of being powered by the electrical system of the vehicle.

### BACKGROUND OF THE INVENTION

Elderly and infirm individuals often find it difficult to address vehicle problems such as flat tires at the time of occurrence. In addition, motorists seek simple and safe ways to fix unexpected problems on the roadways. When a tire goes flat along a busy road, the flat tire needs replaced with the spare as soon as possible. It is desirable for the elderly and infirmed to be able to change flat tires on a vehicle. Devices exist for this purpose, but applicant is not aware of any devices which incorporate all of the features of the present invention.

### SUMMARY OF THE INVENTION

In one aspect, the invention generally features a battery powered vehicle jack and wrench kit comprising a battery powered hydraulic jack having a body, a top end and bottom end, for raising and lowering a vehicle, a battery powered impact wrench for tightening and loosening lugnuts on a vehicle. There is a power cord engageable at a respective first end thereof with terminals located on one of such hydraulic jack and such impact wrench and having a means for connecting to a vehicle battery at a respective second end for providing power to a control means. A predetermined plurality of sockets engageable at a first end with the impact wrench and engageable at a second end thereof with a vehicle lugnut and a case for containing such hydraulic jack, impact wrench, power cord and predetermined plurality of predetermined sized sockets therein are included.

### OBJECTS OF THE INVENTION

It is therefore the primary object of the present invention to provide a battery powered vehicle jack and wrench kit that allows a flat tire on a vehicle to be changed while minimizing expended effort.

It is another object of the present invention to provide a battery powered vehicle jack and wrench kit that is powered by a vehicle power source.

It is a further object of the present invention to provide a battery powered vehicle jack and wrench kit that is both lightweight and durable.

It is a yet another object of the present invention to provide a battery powered vehicle jack and wrench kit that is capable of being remotely operated.

It is still another object of the present invention to provide a battery powered vehicle jack and wrench kit that allows safe changing of a vehicle tire.

In addition to the above-described objects and advantages of the battery powered vehicle jack and wrench kit, various other objects and advantages of the present invention will become more readily apparent to the persons who are skilled in the same and related arts from the following more detailed description of the invention, particularly, when such description is taken in conjunction with the attached drawing figures and the appended claims.

### DESCRIPTION OF THE DRAWINGS

FIG. 1 is perspective view of a battery powered vehicle jack and wrench kit.

FIG. 2 is a perspective view of a hydraulic jack included as part of the battery powered vehicle jack and wrench kit.

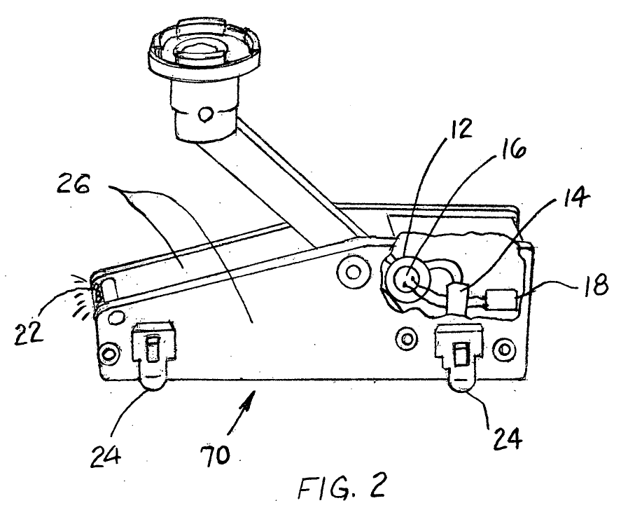

### DETAILED DESCRIPTION OF THE PRESENTLY PREFERRED EMBODIMENT

Prior to proceeding to a much more detailed description of the present invention, it should be noted that identical components which have identical functions have been identified with identical reference numerals throughout the several views illustrated in the drawing figures for the sake of clarity and understanding of the invention.

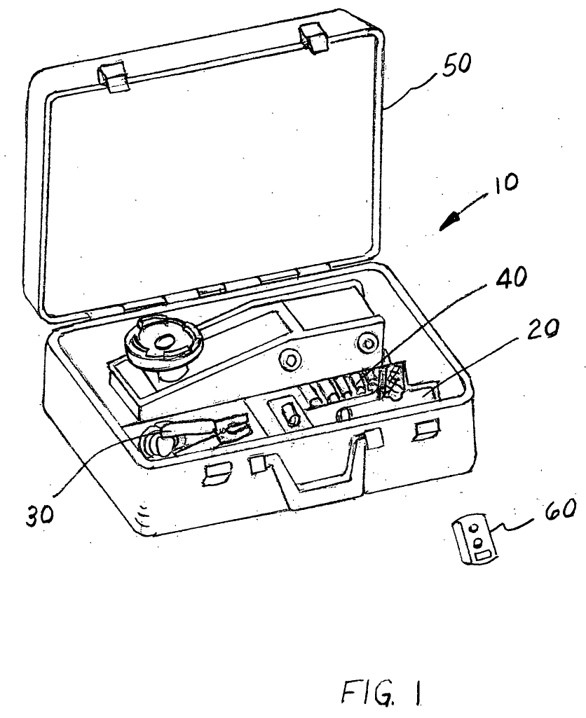

Referring initially to FIG. 1 a battery powered vehicle jack and wrench kit constructed according to a presently preferred embodiment of the invention is generally indicated by reference numeral 10. The battery powered vehicle jack and wrench kit (10) further includes a battery powered hydraulic jack (70) having a body (26), a top end and bottom end, for raising and lowering a vehicle, a battery powered impact wrench (20) for tightening and loosening lugnuts on a vehicle.

There is a power cord (30) engageable at a respective first end thereof with terminals (not shown) located on one of the hydraulic jack and impact wrench and has a means for connecting to a vehicle battery at a respective second end for providing power to a control means (18).

Battery powered vehicle jack and wrench kit (10) includes a predetermined plurality of sockets (40) engageable at a first end with said impact wrench and engageable at a second end thereof with a vehicle lugnut. In a preferred embodiment, such predetermined plurality of sockets (40) is at least two of a predetermined size, and more preferably the predetermined plurality of sockets is four.

Hydraulic jack (70) includes a hydraulic pump (12) in fluid communication with a normally closed solenoid (14) and hydraulic jack (70) for applying pressure to hydraulic fluid contained within said hydraulic jack. This pressure will allow the jack to lift a vehicle. The normally closed solenoid (14) is in fluid communication with hydraulic pump (12) and a fluid reservoir contained within the hydraulic jack (70), and is in electrical communication with a control means (18) for controlling the flow of hydraulic fluid. Hydraulic jack includes an electric motor (16) in electrical communication with control means (18) and is engageably connected to hydraulic pump (12) for driving the hydraulic pump (12). Hydraulic jack (70) also includes a control means (18) that is in electrical communication with the normally closed solenoid (14), electric motor (16) and terminals (not shown) for transmitting electrical control signals. The hydraulic jack (70) includes a predetermined plurality of wheels engageably connected to the body (26) of such hydraulic jack for allowing movement of the hydraulic jack (70). The hydraulic jack (70) includes a light (22) at a front end thereof in electrical communication with said terminals located on said jack for illumination.

The hydraulic jack (70) has a body (26) made from a lightweight material, and in a preferred embodiment, the body (26) is made from aluminum. In the preferred embodiment the hydraulic jack is a floor style jack.

The battery powered vehicle jack and wrench kit (10) includes a case (50) for containing the hydraulic jack (70), impact wrench (20), power cord (30) and predetermined plurality of sockets (40) therein.

Hydraulic jack (70) further includes a wireless control means (18) in electrical communication with the normally closed solenoid (14) and electric motor (16), and is capable of receiving a wireless signal for controlling the normally closed solenoid (14) and electric motor (16). Hydraulic jack (70) further includes a wireless transmitter (60) for sending control signals to the wireless control means (18).

While the present invention has been described by way of a detailed description of a particularly preferred embodiment, it will be readily apparent to those of ordinary skill in the art that various substitutions of equivalents may be affected without departing from the spirit or scope of the inventions set forth in the appended claims.

I claim:

1. A battery powered vehicle jack and wrench kit comprising:
(a) a battery powered hydraulic jack having a body, a top end, front end and bottom end, for raising and lowering a vehicle;
(b) a battery powered impact wrench for tightening and loosening lugnuts on a vehicle;
(c) a power cord engageable at a respective first end thereof with terminals located on one of said hydraulic jack and said impact wrench and having a means for connecting to a vehicle battery at a respective second end for providing power to a control means;
(d) a predetermined plurality of sockets engageable at a first end with said impact wrench and engageable at a second end thereof with a vehicle lugnut; and
(e) a case for containing said hydraulic jack, said impact wrench, said power cord and said predetermined plurality of sockets therein.

2. A battery powered vehicle jack and wrench kit according to claim 1, wherein said hydraulic jack includes a hydraulic pump in fluid communication with a normally closed solenoid and said hydraulic jack for applying pressure to hydraulic fluid contained within said hydraulic jack;

3. A battery powered vehicle jack and wrench kit according to claim 1, wherein said hydraulic jack includes a hydraulic pump, a normally closed solenoid, fluid reservoir and electrical control means, said normally closed solenoid in fluid communication with said hydraulic pump and said fluid reservoir contained within said hydraulic jack, and in electrical communication with said control means for controlling the flow of hydraulic fluid.

4. A battery powered vehicle jack and wrench kit according to claim 1, wherein said hydraulic jack includes an electric motor, hydraulic pump and control means, said electric motor in electrical communication with said control means and engageably connected to said hydraulic pump for driving said hydraulic pump.

5. A battery powered vehicle jack and wrench kit according to claim 1, wherein said hydraulic jack includes normally closed solenoid, control means and terminals, said control means in electrical communication with said normally closed solenoid and said electric motor and said terminals for transmitting electrical control signals.

6. A battery powered vehicle jack and wrench kit according to claim 1, wherein said hydraulic jack includes a predetermined plurality of wheels engageably connected to said body of said hydraulic jack for allowing movement of said hydraulic jack.

7. A battery powered vehicle jack and wrench kit according to claim 1, wherein said predetermined plurality of sockets is at least two sockets of a predetermined size.

8. A battery powered vehicle jack and wrench kit according to claim 1, wherein said predetermined plurality of sockets is four sockets of predetermined size.

9. A battery powered vehicle jack and wrench kit according to claim 1, wherein said hydraulic jack includes a light and terminals, said light at a front end thereof in electrical communication with said terminals located on said jack for illumination.

10. A battery powered vehicle jack and wrench kit according to claim 1, wherein said hydraulic jack has a body made from a lightweight material.

11. A battery powered vehicle jack and wrench kit according to claim 1, wherein said hydraulic jack has a body made from aluminum.

12. A battery powered vehicle jack and wrench kit according to claim 1, wherein said hydraulic jack having a body, top end, front end and bottom end includes a hydraulic pump in fluid communication with a normally closed solenoid and said hydraulic jack for applying pressure to hydraulic fluid contained within said hydraulic jack, a normally closed solenoid having a fluid connection to said hydraulic pump and a fluid reservoir contained within said hydraulic jack and in electrical communication with a control means for controlling the flow of hydraulic fluid, an electric motor in electrical communication with said control means and engageably connected to said hydraulic pump for driving said hydraulic pump, said control means in electrical communication with said normally closed solenoid and said electric motor and said terminals for controlling electrical signals sent to said electric motor and said normally closed solenoid, a light located at a front end of said hydraulic jack in electrical communication with said terminals located on said hydraulic jack for illumination, and a predetermined plurality of wheels engageably connected to said body of said hydraulic jack for allowing movement of said hydraulic jack.

13. A battery powered vehicle jack and wrench kit according to claim 12, wherein said hydraulic jack has a body made from a lightweight material.

14. A battery powered vehicle jack and wrench kit according to claim 12, wherein said hydraulic jack has a body made from aluminum.

15. A battery powered vehicle jack and wrench kit according to claim 12, wherein said hydraulic jack includes a wireless control means in electrical communication with said normally closed solenoid and said electric motor capable of receiving a wireless signal for controlling said normally closed solenoid and said electric motor.

16. A battery powered vehicle jack and wrench kit according to claim 12, wherein said hydraulic jack includes a wireless control means and a wireless transmitter, said wireless transmitter sending control signals to said wireless control means.
